(19) United States
(12) Patent Application Publication
(10) Pub. No.: US 2019/0057264 A1
(43) Pub. Date: Feb. 21, 2019

(54) DETECTING OBJECTS IN VEHICLES

(71) Applicant: Ford Global Technologies, LLC, Dearborn, MI (US)

(72) Inventors: David J. Schmidt, Dearborn, MI (US); Richard Alan Kreder, Northville, MI (US)

(73) Assignee: Ford Global Technologies, LLC, Dearborn, MI (US)

(21) Appl. No.: 15/679,103

(22) Filed: Aug. 16, 2017

(51) Int. Cl. G06K 9/00; G05D 1/00; B60R 11/04

(52) U.S. Cl. CPC G06K 9/00845; G05D 1/0061; B60R 11/04; B60R 2300/105; G06K 9/00362; G05D 1/0088; G05D 2201/0213; G06K 9/00838

(57) ABSTRACT

A computing device in a vehicle, programmed to acquire a first image of a vehicle interior, and, detect an object by comparing the first image of the vehicle interior with a previously acquired second image. The computing device can be further programmed to subtract the second image from the first image to produce a difference image.

### BACKGROUND

Vehicles can be equipped to operate in both autonomous and occupant piloted mode. Vehicles can be equipped with computing devices, networks, sensors and controllers to acquire information regarding the vehicle's environment and to pilot the vehicle based on the information. Safe and comfortable piloting of the vehicle can depend upon acquiring accurate and timely information regarding the vehicles' environment. Computing devices, networks, sensors and controllers can be equipped to analyze their performance, detect when information is not being acquired in an accurate and timely fashion, and take corrective actions including informing an occupant of the vehicle, relinquishing autonomous control or parking the vehicle.

### BRIEF DESCRIPTION OF THE DRAWINGS

FIG. 1 is a block diagram of an example vehicle.

FIG. 2 is a diagram of an example vehicle interior with seating.

FIG. 3 is a diagram of a video image of example vehicle seating.

FIG. 4 is a diagram of a video image of example seating with an object.

FIG. 5 is a diagram of a processed video image with an object.

FIG. 6 is a flowchart diagram of an example process to detect objects in vehicle interiors.

### DETAILED DESCRIPTION

Disclosed herein is a method, comprising, acquiring a first image of a vehicle interior, and, detecting an object by determining that the first image lacks a pattern included in a stored second image. The second image can be subtracted from the first image to produce a difference image and detecting the object by determining a size and location based on the difference image, wherein detecting the object includes comparing the size to a predetermined minimum size and when the location includes a vehicle seat, an object weight can be determined and the object weight can be compared to a predetermined occupant minimum weight to determine if the object is an occupant.

The first image can be acquired by acquiring infrared light wavelengths and blocking visible light wavelengths. The pattern can include a checkerboard or grid pattern, wherein the pattern is applied to vehicle seats, vehicle floor, vehicle arm rests, vehicle cup holders and vehicle package shelfs. The first image and the second image can be acquired from infrared video data. A plurality of first video images can be acquired, and an object can be detected by determining that the first image lacks a pattern included in a plurality of stored second video images, wherein the plurality of stored second video images each correspond to one of the plurality of first video images. The plurality of second video images can be subtracted from the corresponding first image to produce a plurality of difference images and the object can be detected by determining a size and location based on the plurality of difference images.

Further disclosed is a computer readable medium, storing program instructions for executing some or all of the above method steps. Further disclosed is a computer programmed for executing some or all of the above method steps, including a computer apparatus, programmed to determine that the first image lacks a pattern included in a stored second image. The computer can be further programmed to subtract the second image from the first image to produce a difference image and detecting the object by determining a size and location based on the difference image, wherein detecting the object includes comparing the size to a predetermined minimum size and when the location includes a vehicle seat, an object weight can be determined and the object weight can be compared to a predetermined occupant minimum weight to determine if the object is an occupant.

The computer can be further programmed to acquire a first image by acquiring infrared light wavelengths and blocking visible light wavelengths. The pattern can include a checkerboard or grid pattern, wherein the pattern is applied to vehicle seats, vehicle floor, vehicle arm rests, vehicle cup holders and vehicle package shelfs. The computer can be further programmed to acquire the first image and the second image from infrared video data. A plurality of first video images can be acquired, and an object can be detected by determining that the first image lacks a pattern included in a plurality of stored second video images, wherein the plurality of stored second video images each correspond to one of the plurality of first video images. The computer can be further programmed to subtract the plurality of second video images from the corresponding first images to produce a plurality of difference images and the object can be detected by determining a size and location based on the plurality of difference images.

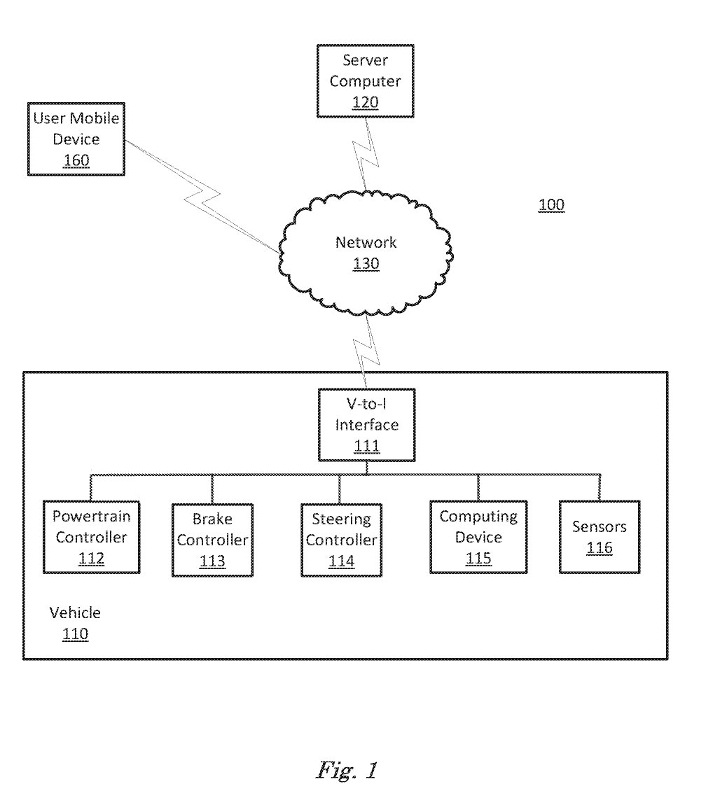

FIG. 1 is a diagram of a vehicle information system 100 that includes a vehicle 110 operable in autonomous (“autonomous” by itself in this disclosure means “fully autonomous”) and occupant piloted (also referred to as non-autonomous) mode in accordance with disclosed implementations. Vehicle 110 also includes one or more computing devices 115 for performing computations for piloting the vehicle 110 during autonomous operation. Computing devices 115 can receive information regarding the operation of the vehicle from sensors 116.

The computing device 115 includes a processor and a memory such as are known. Further, the memory includes one or more forms of computer-readable media, and stores instructions executable by the processor for performing various operations, including as disclosed herein. For example, the computing device 115 may include programming to operate one or more of vehicle brakes, propulsion (e.g., control of acceleration in the vehicle 110 by controlling one or more of an internal combustion engine, electric motor, hybrid engine, etc.), steering, climate control, interior and/or exterior lights, etc., as well as to determine whether and when the computing device 115, as opposed to a human operator, is to control such operations.

The computing device 115 may include or be communicatively coupled to, e.g., via a vehicle communications bus as described further below, more than one computing devices, e.g., controllers or the like included in the vehicle 110 for monitoring and/or controlling various vehicle components, e.g., a powertrain controller 112, a brake controller 113, a steering controller 114, etc. The computing device 115 is generally arranged for communications on a vehicle communication network such as a bus in the vehicle 110 such as a controller area network (CAN) or the like; the vehicle 110 network can include wired or wireless communication mechanism such as are known, e.g., Ethernet or other communication protocols.

Via the vehicle network, the computing device 115 may transmit messages to various devices in the vehicle and/or receive messages from the various devices, e.g., controllers, actuators, sensors, etc., including sensors 116. Alternatively, or additionally, in cases where the computing device 115 actually comprises multiple devices, the vehicle communication network may be used for communications between devices represented as the computing device 115 in this disclosure. Further, as mentioned below, various controllers or sensing elements may provide data to the computing device 115 via the vehicle communication network.

In addition, the computing device 115 may be configured for communicating through a vehicle-to-infrastructure (V-to-I) interface 111 with a remote server computer 120, e.g., a cloud server, via a network 130, which, as described below, may utilize various wired and/or wireless networking technologies, e.g., cellular, BLUETOOTH® and wired and/or wireless packet networks. Computing device 115 may be configured for communicating with other vehicles 110 through V-to-I interface 111 using vehicle-to-vehicle (V-to-V) networks formed on an ad hoc basis among nearby vehicles 110 or formed through infrastructure-based networks. The computing device 115 also includes nonvolatile memory such as is known. Computing device 115 can log information by storing the information in nonvolatile memory for later retrieval and transmittal via the vehicle communication network and a vehicle to infrastructure (V-to-I) interface 111 to a server computer 120 or user mobile device 160.

As already mentioned, generally included in instructions stored in the memory and executed by the processor of the computing device 115 is programming for operating one or more vehicle 110 components or subsystems, e.g., braking, steering, propulsion, etc., without intervention of a human operator. Using data received in the computing device 115, e.g., the sensor data from the sensors 116, the server computer 120, etc., the computing device 115 may make various determinations and/or control various vehicle 110 components and/or operations without a driver to operate the vehicle 110. For example, the computing device 115 may include programming to regulate vehicle 110 operational behaviors such as speed, acceleration, deceleration, steering, etc., as well as tactical behaviors such as a distance between vehicles and/or amount of time between vehicles, lane-change, minimum gap between vehicles, left-turn-across-path minimum, time-to-arrival at a particular location and intersection (without signal) minimum time-to-arrival to cross the intersection.

Controllers, as that term is used herein, include computing devices that typically are programmed to control a specific vehicle subsystem. Examples include a powertrain controller 112, a brake controller 113, and a steering controller 114. A controller may be an electronic control unit (ECU) such as is known, possibly including additional programming as described herein. The controllers may communicatively be connected to and receive instructions from the computing device 115 to actuate the subsystem according to the instructions. For example, the brake controller 113 may receive instructions from the computing device 115 to operate the brakes of the vehicle 110.

The one or more controllers 112, 113, 114 for the vehicle 110 may include known electronic control units (ECUs) or the like including, as non-limiting examples, one or more powertrain controllers 112, one or more brake controllers 113 and one or more steering controllers 114. Each of the controllers 112, 113, 114 may include respective processors and memories and one or more actuators. The controllers 112, 113, 114 may be programmed and connected to a vehicle 110 communications bus, such as a controller area network (CAN) bus or local interconnect network (LIN) bus, to receive instructions from the computer 115 and control actuators based on the instructions.

Sensors 116 may include a variety of devices known to provide data via the vehicle communications bus. For example, a radar fixed to a front bumper (not shown) of the vehicle 110 may provide a distance from the vehicle 110 to a next vehicle in front of the vehicle 110, or a global positioning system (GPS) sensor disposed in the vehicle 110 may provide geographical coordinates of the vehicle 110. The distance(s) provided by the radar and/or other sensors 116 and/or the geographical coordinates provided by the GPS sensor may be used by the computing device 115 to operate the vehicle 110 autonomously or semi-autonomously.

The vehicle 110 is generally a land-based autonomous vehicle 110 having three or more wheels, e.g., a passenger car, light truck, etc. The vehicle 110 includes one or more sensors 116, the V-to-I interface 111, the computing device 115 and one or more controllers 112, 113, 114.

The sensors 116 may be programmed to collect data related to the vehicle 110 and the environment in which the vehicle 110 is operating. By way of example, and not limitation, sensors 116 may include, e.g., altimeters, cameras, LIDAR, radar, ultrasonic sensors, infrared sensors, pressure sensors, accelerometers, gyroscopes, temperature sensors, pressure sensors, hall sensors, optical sensors, voltage sensors, current sensors, mechanical sensors such as switches, etc. The sensors 116 may be used to sense the environment around the vehicle in which the vehicle 110 is operating, the “environment” around the vehicle referring to ambient conditions external to the vehicle body, such as weather conditions (e.g., wind speed, presence or absence and/or type of precipitation, ambient temperature, intensity of ambient light, etc.), the grade of a road, the location of a road or locations of neighboring vehicles 110. The sensors 116 may further be used to collect data including dynamic vehicle 110 data related to operations of the vehicle 110 such as velocity, yaw rate, steering angle, engine speed, brake pressure, oil pressure, the power level applied to controllers 112, 113, 114 in the vehicle 110, connectivity between components and electrical and logical health of the vehicle 110.

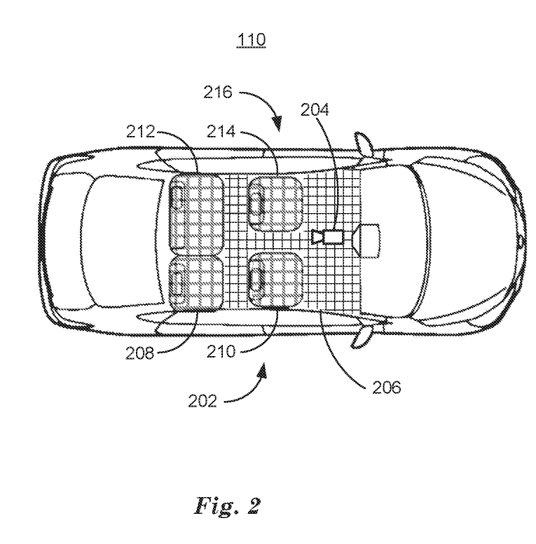

FIG. 2 is a diagram of a top view of a vehicle 110 with the roof removed to show portions of vehicle interior 202. While occupying a vehicle for transport, occupants can enter, occupy, and exit the vehicle 110. From time to time occupants unwantedly leave personal objects like cell phones, bags, beverage cups, etc. in vehicles 110. Objects can be used and set down on surfaces in vehicle interior 202 and forgotten, or objects can be inadvertently lost from bags or pockets and not noticed upon exiting vehicle 110, for example. Recovering a forgotten object from an unattended vehicle for hire, for example, can require a human to detect and retrieve the object. To address the lack of current technology to provide information about lost objects, it is possible to permit a human to access video images of vehicle interior 202; the vehicle interior 202 can be configured with one or more video cameras 204 to view surfaces in vehicle interior such as floor 206 and seats 208, 210, 212, 214 and other surfaces in vehicle interior 202 capable of supporting an object like ledges, arm rests, cup holders, package shelves and dashboards, for example. By configuring vehicle interior 202 with video cameras 204 to view portions of vehicle interior 202 capable of supporting an object, and operatively connecting video cameras 204 with computing device 115, video images of vehicle interior 202 can be acquired and stored at computing device 115.

Once video images of vehicle interior 202 are acquired and stored at computing device 115, they are available for transmission to a server via V-to-I interface 111 for inspection by a human to determine if an object has been forgotten and left in a vehicle 110. The human can be an owner or otherwise authorized person with authorization to view video images from vehicle interior 202. Privacy concerns can cause video cameras 204 and computing device 115 to be configured to prevent unauthorized acquisition of video images from vehicle interior 202. When an occupant has forgotten an object in a vehicle 110, and the occupant is not the owner of the vehicle 110, for example, the occupant could contact a server operatively connected to vehicle 110 via a wide area network like a cellular network, apply for and receive authorization to view video images from the vehicle, and use the video images acquired from the vehicle 110 to determine if an object was present in the vehicle interior 202.

In addition to acquiring and storing video images of vehicle interior 202, computing device 115 can be programmed to using machine vision techniques to process video images of vehicle interior 202 to determine whether one or more objects are present in vehicle interior 202 by comparing video images taken without objects present with video images taken with objects present. To assist computing device 115 in processing video images to detect the presence of objects in vehicle interior 202, floor 206 and seats 208, 210, 212, 214 can be provided with a pattern 216 applied to the surface of floor 206 and seats 208, 210, 212, 214 and other surfaces of vehicle interior 202. The pattern 216 applied to surfaces in vehicle interior 202 can be any type of pattern that is visually different than the appearance of objects. Pattern 216 can be applied to surfaces in vehicle interior 202 to permit computing device 115 or a human observer to detect the presence of objects in vehicle interior 202 more easily. For example, a cell phone with a black case on seats 208, 210, 212, 214 having black upholstery can be difficult to detect in a video image.

Applying pattern 216 to surfaces in vehicle interior 202 including the floor 206 and seats 208, 210, 212, 214 can permit computing device 115 and human observers to detect objects in vehicle interior 202 that could otherwise be undetectable due to similarity between the appearance of the object and the vehicle interior 202 surface upon which they are positioned. The pattern 216 applied to the surfaces can be any pattern that can be distinguished from objects, including geometric patterns like the grid pattern 216 shown, or geometric patterns like a checkerboard or stripes, or random patterns that include details that can be distinguished from objects, for example. The pattern 216 can be any predetermined pattern including checkerboard, grid, dots, lines, geometric images, etc., or any pattern 216 that can be applied to floor 206, seats 208, 210, 212, 214 or trim materials that make it possible to discern objects in acquired video images that block or disrupt the pattern 216 when vehicle interior 202 is empty of occupants. The pattern 216 can be included in fabric or carpet that covers floor 206 and seats 208, 210, 212, 214 by weaving or dying, for example, or included in a cover that covers these surfaces.

The pattern 216 can be included in surfaces in vehicle interior 202 without being visible to occupants by making the pattern 216 visible only at infrared (IR) wavelengths of light. The pattern 216 can be made visible only at IR wavelengths by using an IR dye to form the pattern 216 or by using a material that reflects or absorbs IR light differently than visible light to form the pattern 216. By making pattern 216 reflect or absorb light differently at IR wavelengths than at visible wavelengths, the pattern 216 can be essentially invisible in video images acquired at wavelengths visible to humans. Video cameras 204 can be configured to acquire IR video images at IR wavelengths that clearly show pattern 216 that is not otherwise visible to humans or visible light video cameras 204, for example

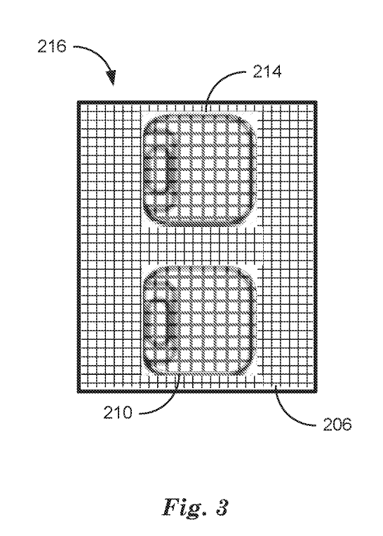

FIG. 3 is a diagram of a reference video image 300 acquired with video cameras 204 showing a portion of vehicle interior 202 including a portion of floor 204 and seats 210, 214 covered with pattern 216. The reference video image 300 can be either a visible light reference video image 300, wherein the pattern 216 is visible to humans and visible light video cameras 204, or an IR light video image 300, wherein the pattern 216 is only made visible by acquiring the reference video image 300 with an IR video camera 204. In either case, reference video image 300 can be acquired and stored by computing device 115

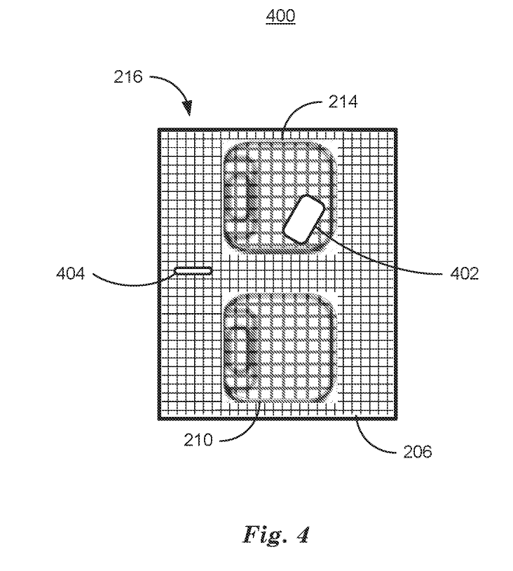

FIG. 4 is a diagram of a test video image 400 acquired with video cameras 204 showing vehicle interior 202 including floor 204 and seats 210, 214 covered with pattern 216 and including first and second objects 402, 404. As can be seen in test video image 400, first and second objects 402, 404 can block pattern 216 and appear un-patterned in test video image 400. This can be the case, whether test video image 400 is acquired in visible or IR wavelengths as discussed above in relation to FIGS. 2 and 3.

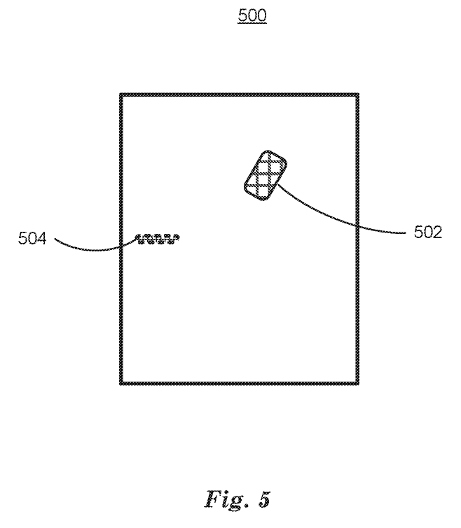

FIG. 5 is a diagram of a result video image 500 that is the result of subtracting acquired and stored reference video image 300 from acquired and stored test video image 400. Because most image details of floor 204 and seats 210, 214, along with pattern 216, do not change from reference video image 300 to test video image 400, those details will be equal in both images and will be subtracted out to near zero values. The only portions of result video image 500 that retain non-zero content are portions of result video image 500 associated with first and second objects 502, 504, where non-zero content is defined as image pixels containing values greater than a predetermined minimum value. Requiring values greater than a predetermined minimum value can filter out non-zero content associated with electronic “noise” caused by slight variations in pixel value due to the acquisition process. Note that subtracting reference video image 300 from test video image 400 can form image details similar to the pattern 216 on the images of first and second objects 502, 504 due to the subtraction process. Reference video image 300 and test video image 400 can be normalized before subtraction to account for differences in lighting, for example, thereby making the subtraction process more accurate.

In this fashion, a reference video image 300 and a test video image 400 of vehicle interior 202 can be used to detect the presence of first and second objects 502, 504 present in vehicle interior 202 in result video image 500. In result video image 500, a first object 502 is outlined in solid lines and a second object 504 is outlined in dashed lines. This is because computing device 115 can measure the area or size of a detected first and second objects 502, 504 and process first and second objects 502, 504 differently depending upon the measured size. A second object 504 can be determined to be smaller than a predetermined lower limit, for example. A second object 502 that is smaller than the predetermined limit can be detected but not reported. For example, second object 504 can be determined to be smaller than a pen or pencil, and therefore determined to be smaller than the predetermined limit. This can prevent “nuisance” detections of small objects that may represent real objects and therefore may not be interesting to occupants, for example.

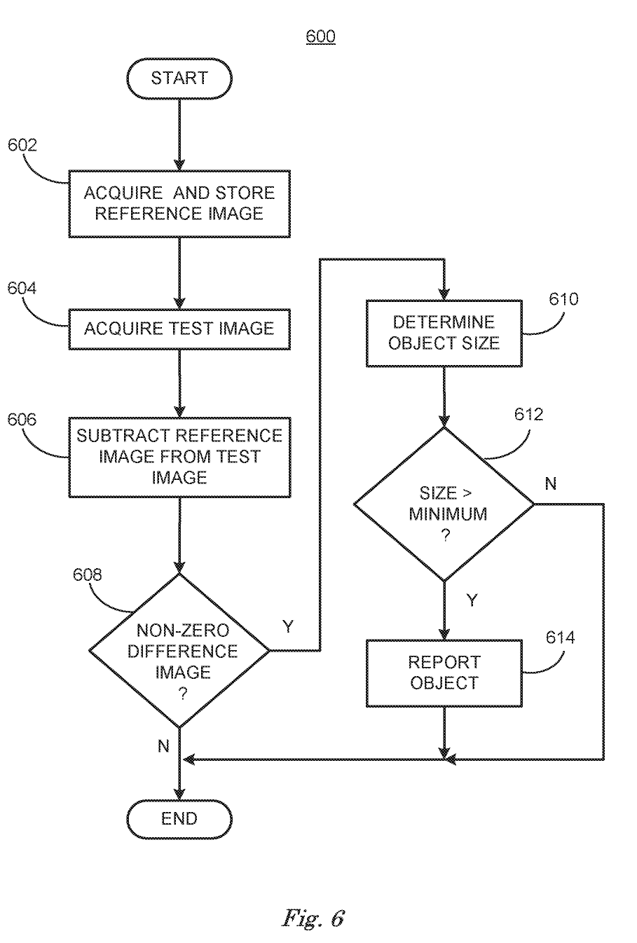

FIG. 6 is a diagram of a flowchart, described in relation to FIGS. 1-5, of a process 600 for detecting the presence of objects 502, 504 in a vehicle interior 202. Process 600 can be implemented by a processor of computing device 115, taking as input information from sensors 116, and executing instructions and sending control signals via controllers 112, 113, 114, for example. Process 600 includes multiple steps taken in the disclosed order. Process 600 also includes implementations including fewer steps or can include the steps taken in different orders.

Process 600 begins at step 602, where a computing device 115 in a vehicle 110 acquires and store a reference image video image 300 as shown in FIG. 3. Computing device 115 can acquire and store a reference video image 300 at any time that it is determined that vehicle interior 202 is free of first and second objects 402, 404, for example, to provide a reference video image 300 that includes only vehicle interior 202 including floor 204, seats 208, 210, 212, 214, and pattern 216. At some time later, at step 604, computing device acquires and stores a test video image 400 as discussed above in relation to FIG. 4. Events that can prompt computing device 115 to acquire and store a test video image 400 include determining that an occupant has exited vehicle 110 or receiving a request from a server via V-to-I interface 111 to acquire and store a test video, for example.

At step 606 computing device 115 subtracts acquired and stored reference video image 300 from acquired and stored test video image 400 to form a result video image 500 as discussed above in relation to FIG. 5. At step 608, computing device can determine if result video image 500 includes non-zero content. As discussed above in relation to FIG. 5, detection of non-zero content can indicate the presence of objects 502, 504 in vehicle interior 202. If no non-zero portions of result video image 500 are detected at step 608, no objects have been detected in result video image 500 and process 600 ends. If non-zero portions of result video image 500 are detected, at step 610 the size of first and second objects 502, 504, for example, can be measured.

At step 610 the size of first and second objects 502, 504 are measured by determining the smallest bounding box in X and Y coordinates can be measured, for example. The size of first and second objects 502, 504 can also be measured by counting the number of video pixels and thereby determining the area included in first and second objects 502, 504, for example. Either or both measures can be used to determine the size of first and second objects 502, 504. At step 612 computing device can examine the measured sizes of first and second objects 502, 504 and compare them to predetermined lower limits. If measured sizes of first and second objects are less than predetermined limits, no objects are reported by computing device 115 and process 600 ends.

If at step 612, computing device 115 determines that at least one measured sizes of first and second objects 502, 504 exceeds the predetermined limits, then at step 614 computing device 115 reports the first and second objects 502, 504 that exceed the limit. Reporting by computing device 115 can include transmitting information, including test and result video images 400, 500 to a server via V-to-I interface 111, for example. A server can include information regarding the last occupant to exit vehicle 110 and use that information to contact the occupant and alert them that an object has been detected. Following this step process 600 ends.

Computing devices such as those discussed herein generally each include instructions executable by one or more computing devices such as those identified above, and for carrying out blocks or steps of processes described above. For example, process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored in files and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, e.g., a reference to an “exemplary widget” should be read as simply referring to an example of a widget.

The adverb “approximately” modifying a value or result means that a shape, structure, measurement, value, determination, calculation, etc. may deviate from an exact described geometry, distance, measurement, value, determination, calculation, etc., because of imperfections in materials, machining, manufacturing, sensor measurements, computations, processing time, communications time, etc.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

We claim:

1. A method, comprising:
acquiring a first image of a vehicle interior; and
detecting an object by determining that the first image lacks a pattern included in a stored second image.

2. The method of claim 1, further comprising: subtracting the second image from the first image to produce a difference image.

3. The method of claim 2, further comprising: detecting the object by determining a size and location based on the difference image.

4. The method of claim 3, wherein detecting the object includes comparing the size to a predetermined minimum size.

5. The method of claim 4, further comprising: when the location includes a vehicle seat, determining an object weight.

6. The method of claim 5, further comprising: comparing the object weight to a predetermined occupant minimum weight to determine if the object is an occupant.

7. The method of claim 6, further comprising: acquiring the first image by acquiring infrared light wavelengths and blocking visible light wavelengths.

8. The method of claim 1, wherein the pattern includes a checkerboard or grid pattern.

9. The method of claim 8, wherein the pattern is applied to vehicle seats, vehicle floor, vehicle arm rests, vehicle cup holders and vehicle package shelves.

10. The method of claim 1, wherein the first image and the second image are acquired from infrared video data.

11. A computer apparatus, programmed to:
acquire a first image of a vehicle interior; and
detect an object by comparing the first image of the vehicle interior with a previously acquired second image.

12. The apparatus of claim 11, further comprising: subtract the second image from the first image to produce a difference image.

13. The apparatus of claim 12, further comprising: detect the object by determining a size and location based on the difference image.

14. The apparatus of claim 13, wherein detect the object includes comparing the size to a predetermined minimum size.

15. The apparatus of claim 14, further comprising: when the location includes a vehicle seat, determining an object weight.

16. The apparatus of claim 15, further comprising: comparing the object weight to a predetermined occupant minimum weight to determine if the object is an occupant.

17. The apparatus of claim 11, further comprising: acquiring the first image by acquiring infrared light wavelengths and blocking visible light wavelengths.

18. The apparatus of claim 17, wherein the pattern includes a checkerboard or grid pattern.

19. The apparatus of claim 18, wherein the pattern is applied to vehicle seats, vehicle floor, vehicle arm rests, vehicle cup holders and vehicle package shelves.

20. The apparatus of claim 19, wherein the first image and the second image are acquired from infrared video data.
